(19) United States
(12) Patent Application Publication
(10) Pub. No.: US 2006/0003120 A1
(43) Pub. Date: Jan. 5, 2006

(54) Process for manufacturing a packaging material

(75) Inventors: Hans Rudolf Nageli, Neuhausen (CH); Franz Peter Hombach, Beringen (CH); Patrik Benz, Rorschach (CH)

Correspondence Address: FISHER, CHRISTEN & SABOL, 1725 K STREET, N.W., SUITE 1108, WASHINGTON, DC, 20006, US

(73) Assignee: ALCAN TECHNOLOGY & MANAGEMENT LTD.

(21) Appl. No.: 11/170,350

(22) Filed: Jun. 30, 2005

(30) Foreign Application Priority Data
Jul. 1, 2004 (EP) 04405405.4

(51) Int. Cl. F16B 4/00

(52) U.S. Cl. 428/35.2; 428/35.7

(57) ABSTRACT

A process for manufacturing a packaging material having at least two films (14) or foils (12) bonded together to a multi-layer laminate (10) via at least one adhesive layer (13) is such that the adhesive layers are of an electron-beam-curable adhesive and the laminate is radiated with electrons to cure the adhesive. The laminate is particularly suitable for manufacturing containers, in particular such for packaging foodstuffs for humans and animals. The laminate production using electron-beam-curable adhesive results in a significant reduction in throughput time and to a reduction in solvent emissions when substituting an electron-beam-curable adhesive for a solvent-based adhesive.

The invention relates to a process for manufacturing a packaging material having at least two films or foils bonded together to a multi-layer laminate via at least one adhesive layer, whereby the adhesive layer/layers is/are are cured. Also within the scope of the invention is a deep drawn container made from the laminate.

Today, aluminium-based sterilisable containers for animal foodstuffs are manufactured by laminating an aluminium foil that may be lacquer-coated and a cast polypropylene (cPP)-film to a high grade sterilisable polyurethane (PUR)-adhesive. The laminate is stored under defined conditions until the adhesive has completely cure-hardened. The final structure is: cPP-film/adhesive layer aluminium foil. After subsequent curing over a period of several days, the finished laminate can be cut to size and dispatched to the customers. The throughput time from receiving the order up to dispatching the finished laminate depends essentially on the time required for the PUR-adhesive to cure-harden.

The object of the invention is to provide a process of the kind mentioned at the start, by means of which the time for curing the adhesive required for lamination purposes, and with that the throughput time can be reduced in comparison with conventional laminate manufacture.

That objective is achieved by way of the invention in that at least one adhesive is of an electron-beam-curable adhesive and the laminate is radiated with electrons to cure the adhesive.

The radiation curing of electron-beam-curable adhesives takes place within a fraction of a second on passing through a radiation unit, whereby the final bond strength is essentially reached when the laminate emerges from the radiation unit and coiled i.e. without any additional time for curing. The advantage of laminate manufacture using electron-beam-curing adhesives is not only the significantly reduced throughput time but also in a reduction of solvent emissions, if solvent-based adhesives can be replaced by electron-beam-curing adhesives.

A preferred laminate exhibits two films or foils and an adhesive layer of an electron-beam-curable adhesive.

A preferred laminate exhibits the following structure: polyolefin-film/adhesive layer of an electron-beam-curable adhesive/aluminium foil.

The laminate may, in addition, exhibit lacquer layers and/or printing on the aluminium foil. Preferred laminates with additional lacquer layers and/or printing are:

Polyolefin-film/adhesive layer of an electron-beam-curable adhesive/aluminium foil/lacquer layer, in particular gold coloured lacquer layer, whereby the lacquer layer is preferably of an electron-beam-curable lacquer, and the laminate is radiated with electrons for the purpose of curing the lacquer.

Polyolefin-film/adhesive layer of an electron-beam-curable adhesive/aluminium foil/lacquer layer, in particular gold coloured lacquer/layer printing, whereby the lacquer layer and/or the printing is preferably of an electron-beam-curable lacquer or printing substance, and the laminate is radiated with electrons in order to cure the lacquer or printing substance.

Polyolefin-film/adhesive layer of an electron-beam-curable adhesive/aluminium foil/lacquer layer/printing/top-layer of lacquer, whereby the lacquer layers and/or the printing are preferably of electron-beam-curable lacquer or printing substances and the laminate is radiated with electrons to cure the lacquer or printing substance.

Preferred polyolefin-films are sealable films of polyethylene (PE) or polypropylene (PP). For sterilisable or high temperature cooking applications PP-films, in particular a cast PP-film, are to be preferred because of the good resistance to conditions involving high temperatures.

The acrylate-based adhesive may contain monomers, oligomers or mixtures of monomers and oligomers. Examples of monomers are mono-, di- and multi-functional acrylates such as phosphoric-acid-ester-acrylates, hydroxy-acrylates, carboxy-acrylates, amino-acrylates, acrylic acid and acryl-amide. Examples of oligomers are epoxy-acrylates, urethane-acrylates, polyester-acrylates, silicon-acrylates and silane-acrylates. The above mentioned monomers and oligomers are either available commercially or can be manufactured using routine methods. The term “acrylate” used here (or “acryl”) includes also “methacrylate” (or “methacryl”), whereby the acrylates are preferred.

The laminate manufactured according to the invention is particularly suitable for manufacturing deep-drawn and sterilisable containers for packaging foodstuffs for humans and animals. Packaging containers manufactured from the laminate by deep drawing are also particularly suitable for portion packaging for meals, packaging for electronic components and battery packs.

Further advantages, features and details are revealed in the following description of preferred examples and with the aid of the drawing which shows schematically in

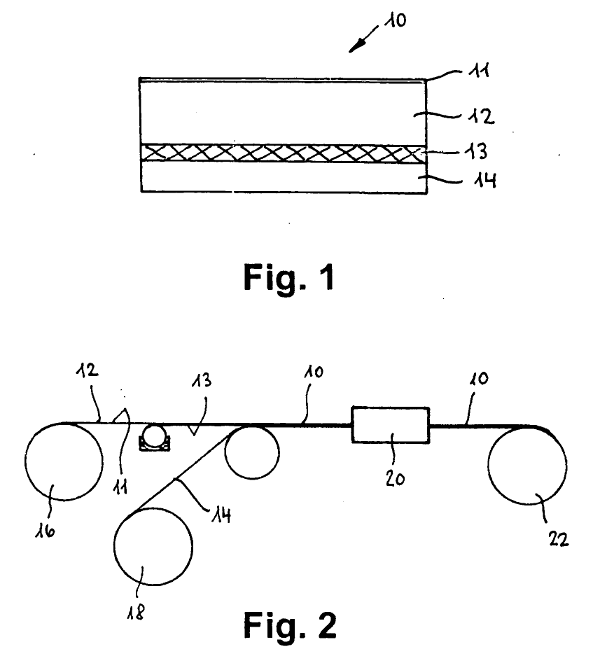

FIG. 1 cross-section through a laminated packaging film,

FIG. 2 manufacture of the packaging film shown in FIG. 1

A packaging film 10 shown in FIG. 1 for manufacturing deep drawn containers for animal food exhibits—as outer side—an aluminium foil 12 with a gold coloured lacquer coating 11 and a sealable cPP-film 14 as inner side. The aluminium foil 12 on the outside is bonded permanently to the sealing film 14 by way of an adhesive layer 13 of electron-beam-curable adhesive. In a typical packaging film 10 the thickness of the aluminium foil is e.g. about 60 μm, the thickness of the cPP-film about 30 μm.

FIG. 2 shows the manufacture of a packaging film 10. The gold lacquered aluminium foil 12 is uncoiled in strip form from a first spool 16 and continuously coated with adhesive 13 on the side not coated with the gold lacquer 11. The sealing film 14 in strip form is led from a second spool 18 onto the aluminium foil 12 coated with adhesive 13 and laminated to this in a continuous manner to form the packaging film 10. The packaging film 10 passes through a radiation unit 20 in which the adhesive layer 13 cures in a fraction of a section due to the electron beam radiation. Thereby, the process parameters i.e. the high voltage and the dosage of radiation are set such that an adequate level of radiation is applied to the adhesive layer 13 to harden it, but only a small level having a negative effect on the cPP-film 14 provided for sealing purposes. On emerging from the radiation unit 20, the packaging film 10 is coiled onto a third spool 22.

Immediately after coiling onto the spool 22, the packaging film 10 with completely cured adhesive layer 13 can be divided into units of commercial required widths using a cutting device.

It is to be understood as self-evident that the bonding of the films or foils in the above lamination process can be such that the adhesive may also be deposited on the other film or foil than that mentioned in the examples.

1. A process for manufacturing a packaging material having at least two films (14) or foils (12) by means of at least one adhesive layer (13) to form a multi-layer laminate (10), whereby the adhesive layer/layers is/are cured, at least one adhesive layer (13) is of an electron-beam-curable adhesive and the laminate (10) is radiated with electrons to cure the adhesive.

2. The process according to claim 1, wherein the laminate (10) exhibits two films (14) or foils (12) and an adhesive layer (13) of an electron-beam-curable adhesive.

3. The process according to claim 2, wherein the laminate (10) exhibits the following structure: PP-film (14)/adhesive (13) of an electron-beam-curable adhesive/aluminum foil (12).

4. The process according to claim 3 wherein the laminate (10) exhibits additional lacquer layers (11) and/or printing on the aluminum foil (12).

5. The process according to claim 3, wherein the laminate (10) exhibits the following structure: PP-film (14)/adhesive layer (13) of an electron-beam curable adhesive/aluminum foil (12)/lacquer layer (11), in particular gold colored lacquer layer.

6. The process according to claim 3, wherein the laminate (10) exhibits the following structure: PP-film (14)/adhesive layer (13) of an electron-beam-curable adhesive/aluminum foil (12)/lacquer layer (11), in particular gold colored lacquer layer/printing.

7. The process according to claim 3, wherein the laminate (10) exhibits the following structure: PP-film (14)/adhesive layer (13) of an electron-beam-curable adhesive/aluminum foil (12)/lacquer layer (11)/printing, outer coat of lacquer.

8. The process according to claim 7, wherein the PP-layer (14) is a cast PP-film.

9. The process according to claim 8, wherein the adhesive layer (13) is an acrylate-based electron-beam-curable adhesive.

10. The deep drawn and sterilizable packaging container for packaging foodstuffs for humans and animals, made from a laminate (10) manufactured utilizing the process according to claim 9.

11. The deep drawn packaging container as portion size packaging for meals, packaging for electronic components and battery packs, made from a laminate (10) manufactured utilizing the process according to claim 9.

12. The process according to claim 5, wherein the lacquer layer is an electron-beam-curable lacquer and the laminate is radiated with electrons to cure the lacquer.

13. The process according to claim 6, wherein the lacquer layer and/or the printing is of an electron-beam-curable lacquer or printing substance, and the laminate is radiated with electrons to cure the lacquer or printing substance.

14. The process according to claim 7, wherein the lacquer layers and/or the printing are of an electron-beam-curable lacquer or printing substance, and the laminate is radiated with electrons to cure the lacquer or printing substance.

15. The process according to claim 3, wherein the PP-layer (14) is a cast PP-film.

16. The process according to claim 1, wherein the adhesive layer (13) is an acrylate-based electron-beam-curable adhesive.

17. The deep drawn and sterilizable packaging container for packaging foodstuffs for humans and animals, made from a laminate (10) manufactured utilizing the process according to claim 1.

18. The deep drawn packaging container as portion size packaging for meals, packaging for electronic components and battery packs, made from a laminate (10) manufactured utilizing the process according to claim 1.
